(19) United States
(12) Patent Application Publication
(10) Pub. No.: US 2006/0037263 A1
(43) Pub. Date: Feb. 23, 2006

(54) Decorative wall member

(76) Inventor: Edward Thomas Hacker JR., Rochester, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/922,543

(22) Filed: Aug. 20, 2004

(51) Int. Cl. E06B 3/66; E06B 1/04

(52) U.S. Cl. 52/211; 52/204.59

(57) ABSTRACT

A decorative wall member may comprise a vertical wall board receiving portion located adjacent to the bottom side of the wall member and extending the width of the wall member. A horizontal or a second vertical wall board receiving portion may be located adjacent the top side and can extend the width of the wall member. Decorative applications can be applied to a decorative base portion located on the front side of the wall member and extending the width or the height of the wall member. There may also be provided at least one rib extending outwardly from the face of the wall member and extending the width of the wall member. The present invention also encompasses a method for decorating a wall portion and a kit including instructions and materials for providing a decorative portion to a wall.

### FIELD OF THE INVENTION

The present invention relates to decorative wall members and wall members configured to receive decorative applications.

### BACKGROUND OF THE INVENTION

It is often desirable to add decorative trim to the interior walls of a room or to the exterior walls of the building. Decorative trim can provide an aesthetically pleasing look and can cover up any unfinished gaps or defects that might exist where walls intersect with other walls, ceilings, or floors. It is desirable that the trim cooperate with the wall, ceiling, or floor in such a manner so as to present a finished appearance.

Traditionally, decorative trim molding assemblies were made from wood or urethane foam. However, these materials have several drawbacks. Moldings manufactured from wood or urethane have become extremely expensive due to the increasing cost of these materials. Additionally, decorative moldings manufactured from wood are subject to shrinkage, warping and splitting which can give rise to significant maintenance and repair costs. It is therefore desired to provide for a decorative trim member that will not suffer from the disadvantages associated with wood such as shrinkage, warping, or splitting.

It is further desired to provide for a decorative trim member that will allow a user to easily customize according to a customer's likes while presenting a finished appearance as a wall member. The member must also be designed to include sufficient strength to support relatively heavy decorative applications such as ceramics and cement. Accordingly, there remains a desire to provide a decorative trim member and system that is cost effective, low maintenance and also possessing desired structural integrity.

### SUMMARY OF THE INVENTION

A decorative wall member comprises a vertical wallboard receiving portion located adjacent to the bottom side of the wall member and extending the width of the wall member. A horizontal or a second vertical wallboard receiving portion may be located adjacent the top side and can extend the width of the wall member. Decorative applications can be applied to a decorative base portion located on the front side of the wall member and extending the width or the height of the wall member. There may also be provided at least one rib extending outwardly from the face of the wall member and extending the width of the wall member. The present invention also encompasses a method for decorating a wall portion and a kit including instructions and materials for providing a decorative portion to a wall.

### BRIEF DESCRIPTION OF THE DRAWINGS

The invention may be more completely understood in consideration of the following detailed description of various embodiments of the invention in connection with the accompanying drawings, in which:

FIG. 1 is a perspective view of a decorative wall member according to an embodiment of the present invention.

FIG. 2 is a perspective view of a decorative wall member according to another embodiment of the invention.

FIG. 3 is a cross section view of the embodiment of the invention taken along the line 3-3 in FIG. 1.

FIG. 4 is a cross section view of the embodiment of the invention taken along the line 4-4 in FIG. 2.

FIG. 5 is a perspective view of a decorative wall member according to another embodiment of the present invention.

FIG. 6 is a cross section of the embodiment of the invention taken along the line 6-6 in FIG. 5.

FIG. 7 is another cross section of the embodiment of the invention taken along the line 7-7 in FIG. 5.

FIG. 8 is a view of an embodiment of the invention when installed.

FIG. 9 is a view of another embodiment of the invention when installed.

### DETAILED DESCRIPTION OF THE DRAWINGS

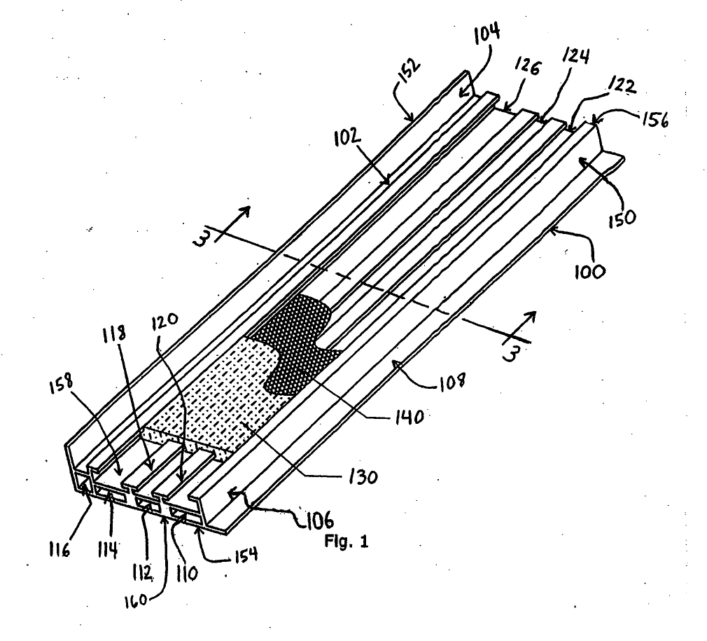

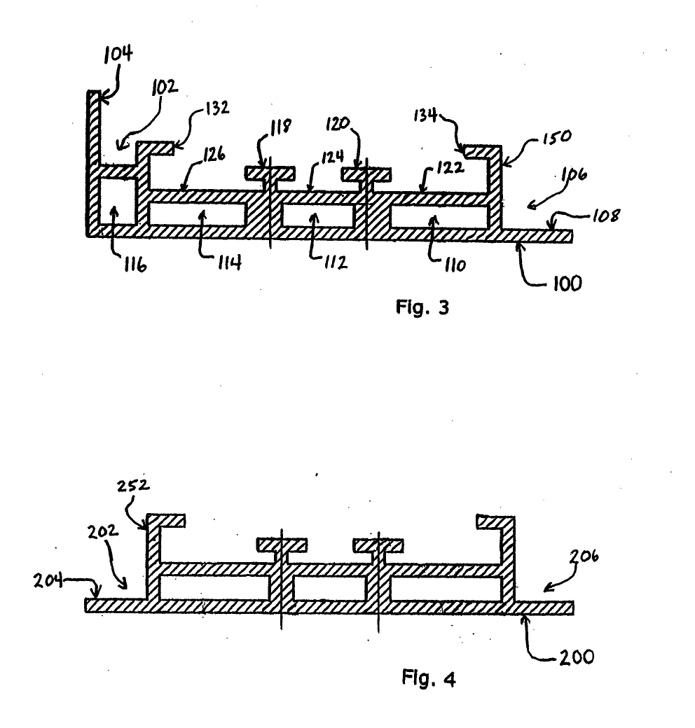

Referring to FIG. 1 and FIG. 3, there is shown a decorative wall member 100 according to an embodiment of the present invention. Wall member 100 includes front surface 158 and an opposing back surface 160 that each span from a first end 154 to a second end 156 of the member 100. The member 100 further defines a top side 152 and an opposing bottom side 150.

A wall receiving portion 106 is disposed on a bottom side 150 and defined by a first flange 108 extending outwardly from the bottom side 150. A horizontal wall, such as ceiling or carpet, receiving portion 102 is disposed in the top side 152 and defined by a second flange 104 that extends outwardly of the front surface 158 at the top side 152 of the member 100. Both wall receiving portion 106 and ceiling receiving portion 102 extend the length of the member 100 from first end 154 to second end 156.

Wall member 100 also includes a decorative base receiving portion 128 that is defined between a first base wall portion 132 and a second base wall portion 134. The decorative base receiving portion 128 includes a first base portion 122, a second base portion 124, and a third base portion 126 that extend from first end 154 to second end 156. A first generally T-shaped rib 118 separates the first base portion 122 and the second base portion 124. A second T-shaped rib 120 separates the second base portion 124 and the third base portion 126. Those having skill in the art will recognize that the ribs 118 and 120 are not limited to having a T-shape.

As shown in FIGS. 1 and 3, wall member 100 further includes a first channel 110, second channel 112, third channel 114, and fourth channel 116 that extend from first end 154 to second end 156. Each of the channels 110, 112, 114 and 116 are included in order to lighten the weight of member 100.

Member 100 is a plastic extruded member according to a preferred embodiment. Extruded plastics are cost efficient, lightweight and corrosion proof. Plastic is not susceptible to moisture and therefore will not decay, warp or splinter like wood. Plastic trim also allows for easy installation. Those having skill in the art will also recognize that the present invention may be constructed of a variety of other materials, including fiberglass and composites, without departing from the scope of the present invention. Also, those having skill in the art will recognize that various portions of the member 100 can be formed of steel and then inserted into the plastic extruding machine in order to form a composite steel/plastic member. Alternatively, steel reinforcing members can be inserted into the plastic extruding machine in order to form a composite steel/plastic member.

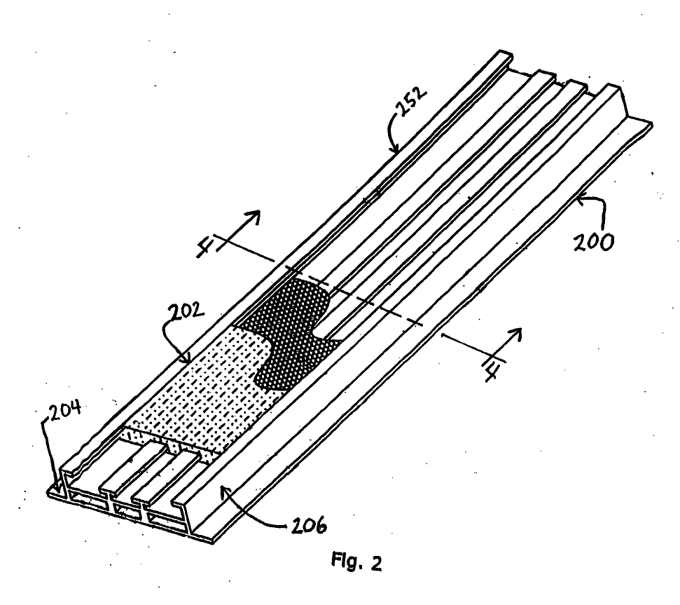

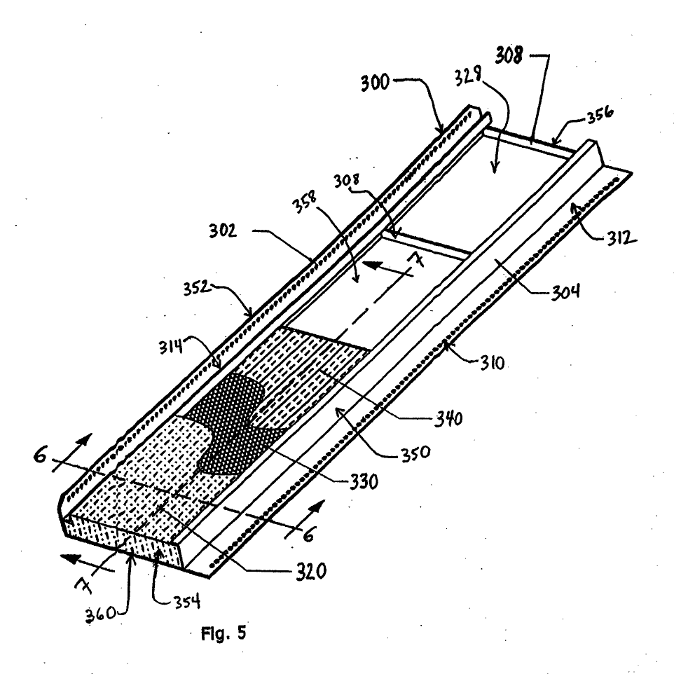

Referring to FIG. 2 and FIG. 4, the decorative wall member 100 of FIGS. 1 and 3 has been modified to cooperate with opposing wall portions. The horizontal ceiling/carpet receiving portion 102 shown in FIGS. 1 and 3 has been replaced with a second vertical wall receiving portion 202. The second vertical wall receiving portion is defined by the top side 252 and a second flange 204 extending outwardly from the top side 252.

Referring now to FIG. 1, a partially filled decorative wall member 100 is shown in accordance with the present invention. In use, the front surface 158 is covered with wire mesh 140 and filled with a fill material 130 spanning from first end 154 to second end 156 and between the first and second base wall portions 132, 134. The member 200 shown in FIG. 2 is filled in a similar manner. Fill material 130 may comprise any number of materials, including grout, cement, plastic wood, epoxy, resin, body builder, BONDO®, ceramics or any other suitable fill material. Fill material 130 may be textured, decorated and/or colored in any number of ways as desired by a user. In one embodiment, a selection of seashells is pressed into the fill material before allowing the fill to cure.

The decorative wall member 100, 200 may also be packaged as a wall decorating kit that comprises one or more wall members 100, fill material and instructions for use. Installation instructions, according to one embodiment, comprise the following:

1. Heat plastic border if in cold area to pre-expand if needed;

2. Cap ends with wood, hold with clamps, such as pipe clamps;

3. Mix pre-determined color and prepare fill material;

4. Pour a first layer of fill into the base receiving portion;

5. Place wire mesh reinforcement in base receiving portion;

6. Pour a second layer of fill and then place decorative items as desired;

7. Allow three days to dry;

8. Seal fill material and decorations with sealer;

9. Ensure sufficient wall backing to support decorative member or shim as needed;

10. Fasten border to wall as needed; and

11. Sheet rock around or trim around to be complete. On exterior, use flashing and seal to keep out the elements.

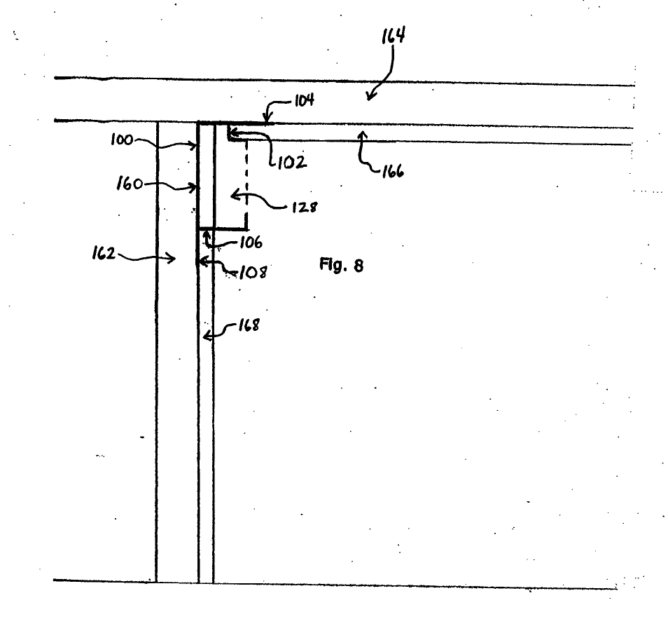

FIG. 8 shows an embodiment of the decorative wall member 100 of FIG. 1 in use in the interior of a building. It should be understood, however, that the member 100 can also be used on the outside of a building. The wall member 100 is fastened to the stud wall 162, with the rear surface 160 and flange 108 flush against stud wall 162 and second flange 104 flush against the ceiling 164. Ceiling sheetrock 166 and vertical wall sheetrock 168 portions fit into respective ceiling/carpet receiving portion 102 and wall receiving portion 106 to provide a finished appearance. While FIG. 8 depicts the wall member 100 protruding beyond the interior surface of the wall sheetrock 168, the decorative base receiving portion 128 may be aligned flush with the wall sheetrock 168 interior surface. Though shown here at the wall/ceiling interface, it is understood that a wall member 100 in accordance with the present invention could also be used at the wall/floor interface.

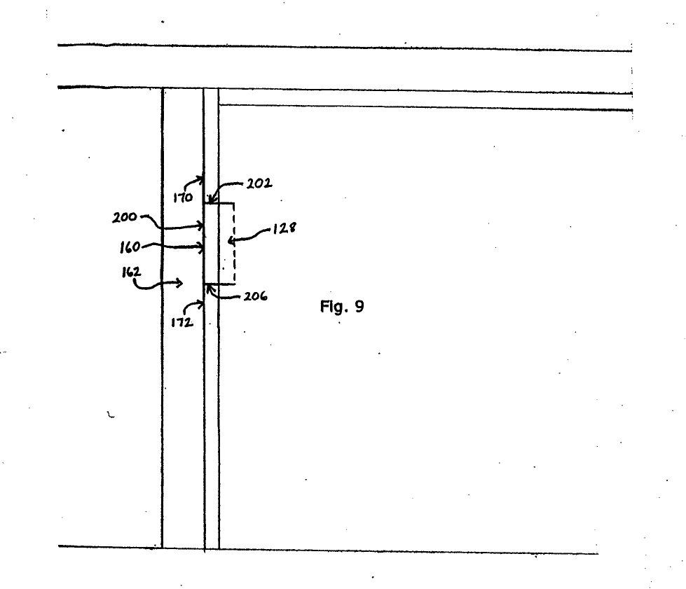

FIG. 9 shows an embodiment of the present invention similar to the one shown in FIG. 2 in use in the interior of a building. Now, the member 200 is disposed between upper and lower sheetrock portions 170 and 172. Member 200 is fastened to the stud wall 162. Upper sheetrock portion 170 fits into the first wall receiving portion 202 and lower sheetrock portion 172 fits into the second wall receiving portion 206 to provide a finished appearance. The decorative base receiving portion 128 may also align with the sheetrock portions 170, 172, rather than protrude out from it. Member 200 can also be used on the exterior of a building.

Referring to FIGS. 5, 6 and 7, a decorative wall member 300 according to another embodiment of the present invention is shown. The wall member 300 may be constructed of steel, or some other suitable strong and rigid material. The assembly 300 defines a first end 354 and second end 356, a top side 352 a bottom side 350, a front surface 358 and a rear surface 360.

The member 300 comprises a ceiling receiving portion 302 disposed at the top side 152 and a wall receiving portion 304 disposed opposite the ceiling portion 302. Each portion 302, 304 extends from the first end 354 to the second end 356. The ceiling/carpet receiving portion 302 is defined by the space between an outwardly extending second flange 314 and a first base receiving portion 332. The wall receiving portion 304 is defined by the intersection of a downwardly extending first flange 312 and a second base receiving portion 334. A decorative base receiving portion is defined between respective first 332 and second 334 base receiving portions. One or more vertically oriented ribs 308 extend between the opposing base receiving portions 332 and 334. Flanges 312 and 314 also receive a plurality of mounting holes or apertures 310.

The respective portions of member 300 can be formed as separate pieces and then welded together. Alternatively, the member 300 can be formed as a unitary piece as part of an extrusion or similar manufacturing process.

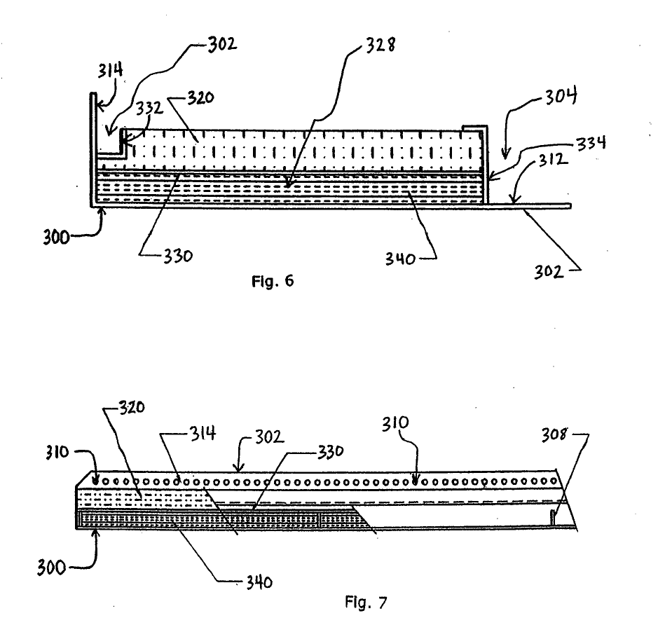

FIGS. 5 and 6 show a decorative wall member 300 in accordance with the present invention showing a partial decorative filling. The base receiving portion 328 is first lined with a STYROFOAM® sheet 340 for lightness. Next, wire mesh 330 is placed over the STYROFOAM® sheet 340. Then, fill material 320 is poured on top of the foam and wire mesh to fill the remaining space in the base receiving portion 328. In use, assembly 300 with decorative portion would interact with the wall in a manner similar to those described above for FIG. 8 and FIG. 9.

A wall member at the ceiling/wall interface as shown in FIG. 8 can also add provide structural support in particular embodiments. A heavy and rigid member, such as one with a steel frame or a composite plastic/steel frame and cement or other heavy fill material can act as a structural weight or anchor to increase the structural integrity of the wall. A heavy duty member could also function as a structural beam, supporting the ceiling and adding strength to the structure to resist outside forces such as high winds in hurricane or tornado conditions.

Although the present invention has been described with reference to preferred embodiments, workers skilled in the art will recognize that changes may be made in form and detail without departing from the spirit and scope of the invention.

1. A decorative wall member comprising:
a front surface and a back surface, each spanning between a first end and a second end and defining a width of the wall member,
a top side and a bottom side defining the height of the wall member;
a vertical wall board receiving portion located adjacent the bottom side of the wall member and extending the width of the wall member;
a horizontal wall board receiving portion located adjacent the top side and extending the width of the wall member;
a decorative base portion located on the front surface of the wall member and extending the width of the wall member; and
at least one rib extending outwardly from the front surface of the wall member and extending the width of the wall member.

2. The wall member of claim 1, further comprising one or more channels defined in the wall member and extending the length of the wall member.

3. The decorative wall member of claim 1, wherein the horizontal wall board receiving portion is generally L-shaped.

4. The wall member of claim 1, wherein the wall member is plastic.

5. The wall member of claim 1, further comprising one or more metal inserts integrated into the wall member.

6. The wall member of claim 1, wherein the ribs are generally T-shaped.

7. A method of providing decorative applications to a wall, the method comprising the steps of:
fastening a decorative wall member to a framed wall;
placing a first drywall board in abutting contact with a first wall board receiving portion of the decorative wall member;
placing a second drywall board in abutting contact with a second wall board receiving portion of the decorative wall member; and
applying a fill material to a decorative base receiving portion of the decorative wall member.

8. The method of claim 6, further comprising the step of applying decorative objects to the fill material.

9. The method of claim 6, further comprising the step of applying a sealant to the fill material after the material cures.

10. A kit for decorating an interior or exterior wall, the kit comprising:
a set of instructions;
a fill material; and
one or more decorative wall members, each decorative wall member comprising:
a front surface and a back surface, each spanning between a first end and a second end and defining a width of the wall member;
a top side and a bottom side defining the height of the wall member;
a wall receiving portion located adjacent the bottom side of the wall member and extending the width of the wall member;
a horizontal surface receiving portion located adjacent the top side and extending the width of the wall member;
a decorative base portion located on the front side of the wall member and extending the width of the wall member; and
a rib extending outwardly from the face of the wall member and extending the width of the wall member.

11. The kit of claim 9, further comprising a sealer for sealing the fill material.

12. A method of providing decorative applications to a wall, the method comprising the steps of:
applying a fill material to a decorative base receiving portion of a decorative wall member;
fastening the decorative wall member to a wall;
placing a first wall portion in abutting contact with a first wall receiving portion of the decorative wall member; and
placing a second wall portion in abutting contact with a second wall receiving portion of the decorative wall member.

13. A method of providing decorative applications to a wall, the method comprising the steps of:
applying a fill material to a decorative base receiving portion of a decorative wall member;
fastening the decorative wall member to a wall;
placing a portion of a wall in abutting contact with a wall receiving portion of the decorative wall member; and
placing a portion of a ceiling in abutting contact with a ceiling receiving portion of the decorative wall member.

14. A generally planar decorative wall member comprising;
first means for receiving a wall board;
second means for receiving a wall board; and
means for retaining a decorative facing.

15. A decorative wall member comprising;
a front surface and a back surface, each spanning between a first end and a second end and defining a width of the wall member,
a top side and a bottom side defining the height of the wall member;
a first wall receiving portion located adjacent the top side of the wall member and extending the width of the wall member;
a second wall receiving portion located adjacent the bottom side of the wall member and extending the width of the wall member;
a decorative base portion located on the front side of the wall member and extending the width of the wall member; and
at least one rib extending outwardly from the face of the wall member and extending the height of the wall member.

16. The decorative wall member of claim 14, wherein the first wall receiving portion is generally L-shaped.

17. The decorative wall portion of claim 14, wherein the wall portion is constructed of steel.

18. The decorative wall of claim 14, further comprising a fill material provided to the decorative base portion and spanning the width of the wall member.
